(19) United States
(12) Patent Application Publication
(10) Pub. No.: US 2022/0271264 A1
(43) Pub. Date: Aug. 25, 2022

(54) METHOD AND SYSTEM FOR MAKING A THIN LITHIUM METAL ANODE FOR A VEHICULAR BATTERY

(71) Applicant: GM Global Technology Operations LLC, Detroit, MI (US)

(72) Inventors: Shaomao Xu, Sterling Heights, MI (US); Ryan C. Sekol, Grosse Point Park, MI (US)

(21) Appl. No.: 17/182,654

(22) Filed: Feb. 23, 2021

(51) Int. Cl. H01M 4/04; H01M 4/38; H01M 4/66

(52) U.S. Cl. CPC H01M 4/0404; H01M 4/382; H01M 4/0419; H01M 4/0409; H01M 4/661; H01M 2004/021

(57) ABSTRACT

A method of making a lithium metal anode for a battery cell is disclosed. The method comprises providing a current collector 12 comprising metal and having a first side 14. The method further comprises applying a metal oxide layer to the first side 14 of the current collector 12. The metal oxide layer comprises metal oxide for enhanced wettability of the first side 14. The method further comprises loading molten lithium to the metal oxide layer at a set temperature in an inert atmosphere to define a molten lithium layer having a first thickness on the metal oxide layer. The method further comprises reducing the first thickness of the molten lithium layer to a second thickness at the set temperature in the inert atmosphere. The method further comprises cooling the molten lithium layer to solidify the molten lithium layer in the inert atmosphere, defining a solid lithium layer on the metal oxide layer.

### INTRODUCTION

The present disclosure relates to lithium metal batteries and more particularly high performance thin lithium metal anodes for a vehicular battery having enhanced efficiency.

Lithium metal batteries have been considered a promising next-generation battery for electric vehicles. As lithium metal provides relatively high specific capacity, improvements continue to be made in the development of lithium batteries, particularly in the solid-phase lithium metal battery production.

### SUMMARY

Thus, while current manufacturing processes and systems achieve their intended purpose, there is a need for a new and improved system and method of manufacturing a thin lithium metal anode for vehicular batteries. According to several aspects, the present disclosure provides a lithium metal anode for a battery along with methods and systems for making the lithium metal anode.

In one aspect of the present disclosure, a method of making a lithium metal anode for a battery cell is provided. In this aspect, the method comprises providing a current collector comprising metal and having a first side. Moreover, the method comprises applying a metal oxide layer to the first side of the current collector. The metal oxide layer comprises metal oxide for enhanced wettability of the first side. The method further comprises loading molten lithium to the metal oxide layer at a set temperature in an inert atmosphere to define a molten lithium layer having a first thickness on the metal oxide layer. The method further comprises reducing the first thickness of the molten lithium layer to a second thickness at the set temperature in the inert atmosphere, and cooling the molten lithium layer to solidify the molten lithium layer in the inert atmosphere, defining a solid lithium layer on the metal oxide layer.

In one example of this aspect, the step of applying the metal oxide to the first side of the current collector comprises applying a precursor layer to the first side of the current collector. The precursor layer comprises a precursor to the metal oxide. The step of applying further comprises heating the precursor layer at a predetermined temperature to decompose the precursor, defining the metal oxide layer disposed on the first side of the current collector. The metal oxide layer comprises the metal oxide to enhance wettability of the first side.

In another example, the precursor is one of zinc nitrate, aluminum nitrate, and titanium nitrate. In yet another embodiment, the metal oxide is one of zinc oxide, aluminum oxide, and titanium oxide. In still another example, the predetermined temperature is between about 200 degrees Celsius and about 300 degree Celsius. In again another example, the set temperature is between about 200 degrees Celsius and about 350 degrees Celsius.

In another example of this aspect, the step of reducing the first thickness of the molten lithium layer comprises reducing the first thickness with a doctor blade. In yet another example, the second thickness of the molten lithium layer is about 10 microns and about 200 microns. In still another example, the metal oxide layer has a thickness of between about 50 nanometers and about 500 nanometers. In again another example, the metal of the current collector comprises one of copper and nickel.

In another aspect of the present disclosure, a system for making a lithium metal anode for a battery cell is provided. The system comprises a current collector comprising metal and having a first side. Moreover, the system comprises a spray unit comprising a precursor solution of a metal oxide compound. In this aspect, the spray unit is configured to apply the precursor solution to the first side of the current collector, defining a precursor layer on the first side.

The system further comprises a heat unit configured to heat the precursor layer at a predetermined temperature to decompose the precursor solution, defining a metal oxide layer disposed on the first side of the current collector. In this aspect, the metal oxide layer comprises the metal oxide compound for enhanced wettability of the first side.

In this aspect, the system further comprises a load unit configured to load molten lithium to the metal oxide layer at a set temperature in an inert atmosphere, defining a molten lithium layer having a first thickness on the metal oxide layer. The load unit comprises a reducer configured to decrease the first thickness of the molten lithium layer to a second thickness at the set temperature in the inert atmosphere. In this aspect, the load unit comprises a cool-down portion to solidify the second thickness of the molten lithium layer at room temperature in the inert atmosphere, defining a solid lithium layer on the metal oxide layer.

The system further comprises a power source configured to power the spray unit, the heat unit, and the load unit. Furthermore, the system comprises a controller configured to control the power to each of the spray unit, the heat unit, and the load unit.

In one embodiment of this aspect, the precursor solution is one of zinc nitrate, aluminum nitrate, and titanium nitrate and the metal oxide compound is one of zinc oxide, aluminum oxide, and titanium oxide.

In another embodiment, the predetermined temperature is between about 200 degrees Celsius and about 300 degree Celsius.

In yet another embodiment, the set temperature is between about 200 degrees Celsius and about 350 degrees Celsius.

In still another embodiment of this aspect, the reducer of the load unit is a doctor blade.

In again another embodiment, the second thickness of the molten lithium layer is between about 10 microns and about 200 microns.

In yet another embodiment of this aspect, the metal oxide layer has a thickness of between about 50 nanometers and about 500 nanometers.

In still another embodiment, the metal of the current collector comprises one of copper and nickel.

In another aspect of the present disclosure, a high-performance lithium metal anode for a battery cell is provided. The lithium metal anode comprises a current collector comprising a metal and has a first side. The lithium metal anode comprises a metal oxide layer disposed on the first side. In this aspect, the metal oxide layer comprises a metal oxide compound for enhanced wettability of the first side. The lithium metal anode further comprises a lithium metal layer disposed on the metal oxide layer and has a thickness of between about 10 microns and about 200 microns for enhanced performance and stable cyclability.

In one embodiment of this aspect, the metal oxide layer has a thickness of between about 50 nanometers and about 500 nanometers for enhanced wettability of the first side of the current collector.

In another aspect of the present disclosure, a method of making a lithium metal anode for a battery cell is provided. The method comprises providing a current collector comprising metal and having a first side. The method further comprises applying a precursor layer to the first side of the current collector. In this aspect, the precursor layer comprises a precursor mixture of a metal oxide compound.

The method further comprises heating the precursor layer at a predetermined temperature to decompose the precursor mixture, defining a metal oxide layer disposed on the first side of the current collector. In this aspect, the metal oxide layer comprises the metal oxide compound to increase the wettability of the first side.

The method further comprises loading molten lithium to the metal oxide layer at a set temperature in an inert atmosphere to define a molten lithium layer having a first thickness on the metal oxide layer.

In this aspect, the method further comprises decreasing the first thickness of the molten lithium layer to a second thickness at the set temperature in the inert atmosphere. Furthermore, the method comprises cooling the molten lithium layer to solidify the molten lithium layer in the inert atmosphere, defining a solid lithium layer on the metal oxide layer.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of a system for making a lithium anode for a battery cell in accordance with one embodiment of the present disclosure.

FIG. 2 is a flowchart of one method of making a lithium anode for a battery cell implemented by the system in FIG. 1 in accordance with one example of the present disclosure.

FIG. 3 is a cross-sectional side view of a lithium anode for a battery cell implemented by the method in FIG. 2 in accordance with one embodiment of the present disclosure.

FIG. 4 is a flowchart of another method of making a lithium anode for a battery cell implemented by the system in FIG. 1 in accordance with another example of the present disclosure.

### DETAILED DESCRIPTION

The following description is merely exemplary in nature and is not intended to limit the present disclosure, application, or uses.

The present disclosure provides systems and methods for manufacturing thin lithium metal anodes for vehicular batteries. The lithium metal anode has a current collector 12 with a metal oxide layer disposed thereon, providing an enhanced wettability of the current collector 12 such that molten lithium may be more effectively loaded thereon. As a result, a relatively thin lithium metal anode may be manufactured. The relatively thin lithium metal anode may then match a cathode capacity to enable high performance, stable cyclability, and enhanced battery efficiency.

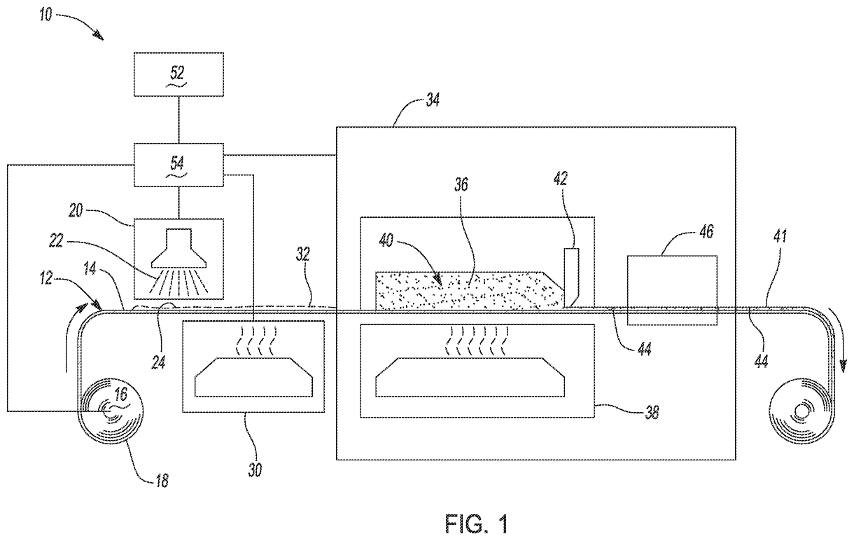

In accordance with one embodiment of the present disclosure, FIG. 1 illustrates a system 10 for making a thin lithium metal anode from molten lithium for a battery cell. As shown, the system 10 comprises a current collector 12 comprising metal and having a first side 14. The current collector 12 may be arranged in a roll 16 having collector layers 18 wound in a spiral as shown in FIG. 1. The roll may be controlled automatically or manually. As will be described in greater detail below, a single layer 18 of the roll 16 may be unwound as the current collector 12 undergoes surface treatment of metal oxide and molten lithium thereon. In this embodiment, the metal of the current collector 12 is comprised of one of copper and nickel.

The system 10 further comprises a spray unit 20 comprising a precursor solution 22 of a metal oxide compound. In this embodiment, the spray unit 20 is configured to apply the precursor solution 22 to the first side 14 of the current collector 12, defining a precursor layer 24 on the first side 14. In this embodiment, the precursor solution 22 comprises one of zinc nitrate, aluminum nitrate, and titanium nitrate. Moreover, the metal oxide compound is one of zinc oxide, aluminum oxide, and titanium oxide. It is to be understood that the precursor of zinc oxide is zinc nitrate, the precursor of aluminum oxide is aluminum nitrate, and the precursor of titanium oxide is titanium nitrate. It is also to be understood that other metal oxides along with corresponding precursors may be used without departing from the spirit or scope of the present disclosure.

Preferably, the precursor solution 22 may comprise the precursor and a solvent. For example, the precursor may be zinc nitrate and the solvent may be ethanol. In one example, the precursor solution 22 may comprise at least 5% weight precursor and the balance of which may be 95% weight solvent. In another embodiment the precursor solution 22 may comprise between about 5% and about 20% weight precursor, and the between about 95% and about 80% solvent. The spray unit 20 may apply the precursor solution 22 to the first side 14 by way of a spray mechanism as discussed above or by any other suitable mechanism of applying the precursor solution 22 to the first side 14 without departing from the spirit or scope of the present disclosure.

The system 10 further comprises a heat unit 30 configured to heat the precursor layer 24 at a predetermined temperature for between about 3 and about 30 minutes to decompose the precursor solution 22. Upon heat at the predetermined temperature, the precursor decomposes to the corresponding metal oxide. The decomposition of the precursor solution 22 defines a metal oxide layer 32 disposed on the first side 14 of the current collector 12.

In this embodiment, the predetermined temperature is between about 200 degrees Celsius and about 300 degrees Celsius. Preferably, the predetermined temperature is between about 200 degrees Celsius and about 250 degrees Celsius. More preferably, the predetermined temperature is about 200 degrees Celsius. Moreover, as discussed, the metal oxide layer 32 comprises the metal oxide compound (e.g., one of zinc oxide, aluminum oxide, and titanium oxide) disposed on the first side 14 of the current collector 12 for enhanced wettability.

Preferably, the metal oxide layer 32 has a thickness of between about 50 nanometers and about 500 nanometers. More preferably, the metal oxide layer 32 has a thickness of between about 100 nanometers and about 200 nanometers. Even more preferably, the metal oxide layer 32 has a thickness of about 100 nanometers.

In this embodiment, the system 10 further comprises a load unit 34 configured to load molten lithium to the metal oxide layer 32 at a set temperature, via a heater 38, in an inert atmosphere. The load unit 34 may be configured to load molten lithium to the metal oxide layer 32 by way of a pool 36 containing molten lithium and arranged to apply or drip molten lithium, e.g., via gravity, on the metal oxide layer 32. In one embodiment, the set temperature is between about 200 degrees Celsius and about 350 degrees Celsius. More preferably, the set temperature is between about 220 degrees Celsius and about 280 degree Celsius. Even more preferably, the set temperature is about 250 degrees Celsius.

It is to be understood that the load unit 34 may load or apply molten lithium on the metal oxide layer 32 by any other suitable means without departing from the spirit or scope of the present disclosure.

The molten lithium loaded on the metal oxide layer 32 defines a molten lithium layer having a first thickness 40 on the metal oxide layer 32. As shown, the load unit 34 comprises a reducer 42, e.g. a doctor blade, configured to decrease the first thickness 40 to a second thickness 44 at the set temperature in the inert atmosphere. In one embodiment, the second thickness 44 of the molten lithium layer 40 is preferably about 10 microns and about 200 microns. More preferably, the second thickness 44 is about 10 microns to about 50 microns. Even more preferably, the second thickness 44 is about 10 microns to about 20 microns.

The enhanced wettability of the current collector 12 by way of the metal oxide layer 32 allows molten lithium to be more effectively loaded thereon such that a relatively thin lithium metal anode may be manufactured. The relatively thin lithium metal anode may match a cathode capacity to enable high performance, stable cyclability, and enhanced battery efficiency.

Moreover, the load unit 34 comprises a cool-down portion 46 to solidify the second thickness 44 of the molten lithium layer 40 at room temperature in the inert atmosphere. The solidification of the second thickness 44 of the molten lithium layer 40 defines a solid lithium layer 41 on the metal oxide layer 32.

It is to be understood that the inert atmosphere may be a closed environment or atmosphere containing gas that is not chemically reactive, particularly to the metal oxide or lithium. For example, the inert atmosphere may be at about 1 atm argon at room temperature. Moreover, the inert atmosphere is preferably a non-nitrogen, a non-oxygen, a non-air, and a non-carbon dioxide atmosphere.

Additionally, the system 10 further comprises a power source 52 configured to power the roll 16, the spray unit 20, the heat unit 30, and the load unit 34. Furthermore, the system 10 comprises a controller 54 configured to control the power to each of the roll 16, the spray unit 20, the heat unit 30, and the load unit 34.

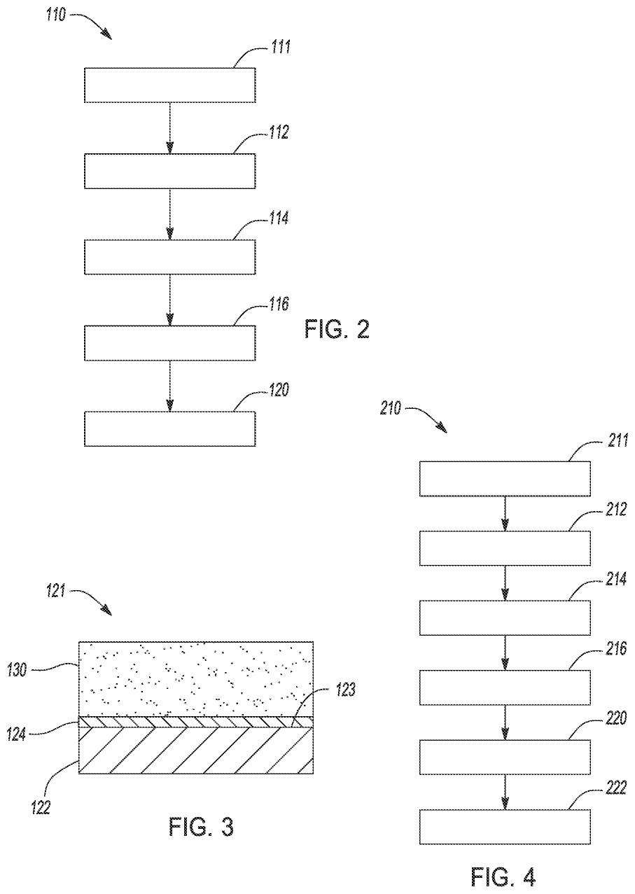

In accordance with one example of the present disclosure, FIG. 2 depicts a method 110 of making a lithium metal anode for a battery cell. As shown, the method 110 comprises providing in box 111 a current collector 12 having a first side 14 and comprising metal. In one example, the metal of the current collector 12 comprises one of copper and nickel.

The method 110 further comprises applying in box 112 a metal oxide layer 32 to the first side 14 of the current collector 12. The metal oxide layer 32 comprises a metal oxide compound for enhanced wettability of the first side 14. Preferably, the metal oxide compound is one of zinc oxide, aluminum oxide, and titanium oxide. Other metal oxides may be used without departing from the spirit or scope of the present disclosure.

In one example the step of applying the metal oxide layer 32 to the first side 14 of the current collector 12 comprises applying a precursor layer 24 to the first side 14 of the current collector 12. In this example, the precursor layer 24 comprises a precursor mixture or solution 22 of a metal oxide compound. In this example, the precursor mixture 22 comprises one of zinc nitrate, aluminum nitrate, and titanium nitrate. Moreover, the metal oxide compound is one of zinc oxide, aluminum oxide, and titanium oxide. It is understood that the precursor of zinc oxide is zinc nitrate, the precursor of aluminum oxide is aluminum nitrate, and the precursor of titanium oxide is titanium nitrate. It is to be understood that other metal oxides along with corresponding precursors may be used without departing from the spirit or scope of the present disclosure.

The step of applying the metal oxide layer 32 further comprises heating the precursor layer 24 at a predetermined temperature to decompose the precursor, defining the metal oxide layer 32 disposed on the first side 14 of the current collector 12.

In one example, the predetermined temperature is between about 200 degrees Celsius and about 300 degree Celsius. Preferably, the predetermined temperature is between about 200 degrees Celsius and about 250 degrees Celsius. More preferably, the predetermined temperature is about 200 degrees Celsius.

Moreover, the metal oxide layer 32 comprises the metal oxide compound (e.g., one of zinc oxide, aluminum oxide, and titanium oxide) disposed on the first side 14 of the current collector 12 for enhanced wettability of the current collector 12. The enhanced wettability by way of the metal oxide layer 32 allows molten lithium to be more effectively loaded thereon such that a relatively thin lithium metal anode may be manufactured. The relatively thin lithium metal anode may match a cathode capacity to enable high performance, stable cyclability, and enhanced battery efficiency.

Preferably, the metal oxide layer 32 has a thickness of between about 50 nanometers and about 500 nanometers. More preferably, the metal oxide layer 32 has a thickness of between about 100 nanometers and about 200 nanometers. Even more preferably, the metal oxide layer 32 has a thickness of about 100 nanometers.

The method 110 further comprises loading in box 114 molten lithium to the metal oxide layer 32 at a set temperature in an inert atmosphere to define a molten lithium layer 40 having a first thickness on the metal oxide layer 32. The step of loading molten lithium on the metal oxide layer 32 is preferably accomplished by the loading unit of the system 10 above. However, molten lithium may be loaded or applied on the metal oxide layer 32 by any other suitable manner without departing from the scope or spirit of the present disclosure.

Preferably, the set temperature is between about 200 degrees Celsius and about 350 degrees Celsius. More preferably, the set temperature is between about 220 degrees Celsius and about 280 degree Celsius. Even more preferably, the set temperature is about 250 degrees Celsius.

The method 110 further comprises reducing in box 116 the first thickness of the molten lithium layer 40 to a second thickness 44 at the set temperature in the inert atmosphere. In one example, the step of reducing the first thickness of the molten lithium layer 40 comprises reducing the first thickness with a doctor blade. In one example, the second thickness 44 of the molten lithium layer 40 is about 10 microns and about 200 microns. More preferably, the second thickness 44 is about 10 microns to about 50 microns. Even more preferably, the second thickness 44 is about 10 microns to about 20 microns.

The method 110 further comprises cooling in box 118 the molten lithium layer 40 to solidify the molten lithium layer 40 in the inert atmosphere, defining a solid lithium layer 41 on the metal oxide layer 32. It is to be understood that the inert atmosphere may be a closed environment or atmosphere containing gas that is not chemically reactive, particularly to the metal oxide or lithium. For example, the inert atmosphere may be at about 1 atm argon at room temperature. Moreover, the inert atmosphere is preferably a non-nitrogen, a non-oxygen, a non-air, and a non-carbon dioxide atmosphere.

In accordance with one embodiment, FIG. 3. Illustrates, a high-performance lithium metal anode 120 for a battery cell. The lithium metal anode 120 is preferably made by the system 10 and method 110 discussed above. As shown, the lithium metal anode 120 comprises a current collector 122 comprising a metal and has a first side 123. Preferably, the metal of the current collector 122 is one of copper and nickel.

The lithium metal anode further comprises a metal oxide layer 124 disposed on the first side 123. In this embodiment, the metal oxide layer 124 comprises a metal oxide compound (e.g., one of zinc oxide, aluminum oxide, and titanium oxide) for enhanced wettability of the first side 14. Preferably, the metal oxide layer 124 has a thickness of between about 50 nanometers and about 500 nanometers for enhanced wettability of the first side 14 of the current collector 12. More preferably, the metal oxide layer 32 has a thickness of between about 100 nanometers and about 200 nanometers. Even more preferably, the metal oxide layer 32 has a thickness of about 100 nanometers.

The lithium metal anode 120 further comprises a lithium metal layer 130 disposed on the metal oxide layer 124. Preferably, the lithium metal layer 130 has a thickness of between about 10 microns and about 200 microns for enhanced performance and stable cyclability. More preferably, the thickness of the lithium metal layer is about 10 microns to about 50 microns. Even more preferably, the second thickness 44 is about 10 microns to about 20 microns.

In accordance with another example of the present disclosure, FIG. 4 depicts a method 210 of making a lithium metal anode for a battery cell. In this example, the method 210 is implemented by system 10 above. The method 210 comprises providing in box 211 a current collector 12 having a first side 14 and comprising metal.

The method 210 further comprises applying in box 212 a precursor layer 24 to the first side 14 of the current collector 12. In this aspect, the precursor layer 24 comprises a precursor mixture or solution 22 of a metal oxide compound. As discussed above, the precursor is one of zinc nitrate, aluminum nitrate, and titanium nitrate. In one example, the metal oxide compound is one of zinc oxide, aluminum oxide, and titanium oxide.

The method 210 further comprises heating in box 214 the precursor layer 24 at a predetermined temperature to decompose the precursor, defining a metal oxide layer 32 disposed on the first side 14 of the current collector 12. In one example, the predetermined temperature is between about 200 degrees Celsius and about 300 degree Celsius. Other examples of the predetermined temperature have been discussed above.

The metal oxide layer 32 comprises the metal oxide to enhance wettability of the first side 14. In one example, the metal oxide layer 32 has a thickness of between about 50 nanometers and about 500 nanometers. Other examples of the thickness of the metal oxide layer 32 have been discussed above.

The method 210 further comprises loading in box 216 molten lithium to the metal oxide layer 32 at a set temperature in an inert atmosphere (e.g., 1 atm argon) to define a molten lithium layer 40 having a first thickness on the metal oxide layer 32. The method 210 further comprises decreasing in box 218 the first thickness of the molten lithium layer 40 to a second thickness 44 at the set temperature in the inert atmosphere. In one example, the set temperature is between about 200 degrees Celsius and about 350 degrees Celsius. Other examples of the set temperature have been discussed above.

In one example, the step of decreasing the first thickness of the molten lithium layer 40 comprises decreasing the first thickness with a doctor blade. In one example, the second thickness 44 of the molten lithium layer 40 is about 10 microns and about 200 microns. Other examples have been discussed above.

The method 210 further comprises cooling in box 220 the molten lithium layer 40 to solidify the molten lithium layer 40 in the inert atmosphere, defining a solid lithium layer 41 on the metal oxide layer 32.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of making a lithium metal anode for a battery cell, the method comprising:
providing a current collector comprising metal and having a first side;
applying a metal oxide layer to the first side of the current collector, the metal oxide layer comprising metal oxide for enhanced wettability of the first side;
loading molten lithium to the metal oxide layer at a set temperature in an inert atmosphere to define a molten lithium layer having a first thickness on the metal oxide layer;
reducing the first thickness of the molten lithium layer to a second thickness at the set temperature in the inert atmosphere; and
cooling the molten lithium layer to solidify the molten lithium layer in the inert atmosphere, defining a solid lithium layer on the metal oxide layer.

2. The method of claim 1 wherein the step of applying the metal oxide to the first side of the current collector comprises:
applying a precursor layer to the first side of the current collector, the precursor layer comprising a precursor to the metal oxide; and
heating the precursor layer at a predetermined temperature to decompose the precursor, defining the metal oxide layer disposed on the first side of the current collector, the metal oxide layer comprising the metal oxide to enhance wettability of the first side.

3. The method of claim 2 wherein the precursor is one of zinc nitrate, aluminum nitrate, and titanium nitrate.

4. The method of claim 2 wherein the metal oxide is one of zinc oxide, aluminum oxide, and titanium oxide.

5. The method of claim 2 wherein the predetermined temperature is between about 200 degrees Celsius and about 300 degree Celsius.

6. The method of claim 1 wherein the set temperature is between about 200 degrees Celsius and about 350 degrees Celsius.

7. The method of claim 1 wherein the step of reducing the first thickness of the molten lithium layer comprises reducing the first thickness with a doctor blade.

8. The method of claim 1 wherein the second thickness of the molten lithium layer is about 10 microns and about 200 microns.

9. The method of claim 1 wherein the metal oxide layer has a thickness of between about 50 nanometers and about 500 nanometers.

10. The method of claim 1 wherein the metal of the current collector comprises one of copper and nickel.

11. A system for making a lithium metal anode for a battery cell, the method comprising:
a current collector comprising metal and having a first side;
a spray unit comprising a precursor solution of a metal oxide compound, the spray unit configured to apply the precursor solution to the first side of the current collector, defining a precursor layer on the first side;
a heat unit configured to heat the precursor layer at a predetermined temperature to decompose the precursor solution, defining a metal oxide layer disposed on the first side of the current collector, the metal oxide layer comprising the metal oxide compound for enhanced wettability of the first side;
a load unit configured to load molten lithium to the metal oxide layer at a set temperature in an inert atmosphere, defining a molten lithium layer having a first thickness on the metal oxide layer, the load unit comprising a reducer configured to decrease the first thickness of the molten lithium layer to a second thickness at the set temperature in the inert atmosphere, the load unit comprising a cool-down portion to solidify the second thickness of the molten lithium layer at room temperature in the inert atmosphere, defining a solid lithium layer on the metal oxide layer;
a power source configured to power the spray unit, the heat unit, and the load unit; and
a controller configured to control the power to each of the spray unit, the heat unit, and the load unit.

12. The system of claim 1 wherein the precursor solution is one of zinc nitrate, aluminum nitrate, and titanium nitrate and wherein the metal oxide compound is one of zinc oxide, aluminum oxide, and titanium oxide.

13. The system of claim 11 wherein the predetermined temperature is between about 200 degrees Celsius and about 300 degree Celsius.

14. The system of claim 11 wherein the set temperature is between about 200 degrees Celsius and about 350 degrees Celsius.

15. The system of claim 11 wherein the reducer of the load unit is a doctor blade.

16. The system of claim 11 wherein the second thickness of the molten lithium layer is about 10 microns and about 200 microns.

17. The system of claim 11 wherein the metal oxide layer has a thickness of between about 50 nanometers and about 500 nanometers.

18. The system of claim 1 wherein the metal of the current collector 12 comprises one of copper and nickel.

19. A high-performance lithium metal anode for a battery cell, the lithium metal anode comprising:
a current collector comprising a metal and having a first side;
a metal oxide layer disposed on the first side, the metal oxide layer comprising a metal oxide compound for enhanced wettability of the first side; and
a lithium metal layer disposed on the metal oxide layer and having a thickness of between about 10 microns and about 200 microns for enhanced performance and stable cyclability.

20. The lithium metal anode of claim 19 wherein the metal oxide layer has a thickness of between about 50 nanometers and about 500 nanometers for enhanced wettability of the first side of the current collector.
